(19) United States
(12) Patent Application Publication
(10) Pub. No.: US 2009/0229275 A1
(43) Pub. Date: Sep. 17, 2009

(54) COMPACT CONFIGURATION FOR CRYOGENIC PUMPS AND TURBINES

(76) Inventor: Joel V. Madison, Sparks, NV (US)

Correspondence Address: RAY K. SHAHANI, ESQ., ATTORNEY AT LAW, TWIN OAKS OFFICE PLAZA, 477 NORTH NINTH AVENUE, SUITE 112, SAN MATEO, CA, 94402-1858, US

(21) Appl. No.: 11/463,000

(22) Filed: Aug. 7, 2006

Related U.S. Application Data
(60) Provisional application No. 60/705,800, filed on Aug. 6, 2005.

(51) Int. Cl. F17C 9/00

(52) U.S. Cl. 62/50.1

(57) ABSTRACT

A single cryogenic liquid vessel in which two cryogenic machines are disposed, supported and operable in tandem. In one embodiment the two cryogenic machines are operable in series or individually, and in another embodiment the two cryogenic machines are operable in parallel or individually. Preferably the machines are supported intermediately relative to the vessel, or at a top of the vessel. In various embodiments the machines are pumps or turbines or expanders.

This invention claims the filing date benefit of U.S. Provisional Application 60/705,800 filed Aug. 6, 2005 by Joel V. Madison.

### BACKGROUND OF THE INVENTION

This invention relates in general to cryogenic machines, such as pumps and turbines designed to operate at cryogenic temperatures, and in particular to two separate cryogenic machines mounted in a common cryogenic pressure vessel and configured to operate in series, in parallel or individually.

For the purposes of this application, cryogenic liquids are those that boil at temperatures at or below −100° C. under atmospheric pressures. An example is liquefied natural gas (LNG) that is typically stored at cryogenic temperatures of about −162° C. (−260° F.) and at substantially atmospheric pressure.

Cryogenic pumps, expanders and turbines are manufactured of aluminum alloys suitable for low temperatures, the same alloys used in aerospace technology. These cryogenic machines are mainly used for liquefied hydrocarbon gases, like methane, ethane, propane, and for LNG which is composed of methane, ethane, propane and other gases, with the major part being methane. LNG is a fuel, hence it is explosive and flammable. Aluminum can burn in air environment. To avoid explosion and fire hazards the aluminum cryogenic pumps, expanders and turbines are mounted in a stainless steel vessel since stainless steel is not flammable like aluminum, however stainless steel cryogenic vessels must be certified for high pressure (due to the pump and turbine pressure) and must be manufactured of expensive stainless steel such as also used in aerospace technology. So the stainless steel vessels are very expensive.

To increase the capacity (mass flow and/or differential head) of a pump, expander or turbine, the dimensions, mainly the diameter of the machine, has to be increased. An increase in the diameter of a cryogenic machine also increases the diameter of the stainless steel pressure vessel containing the machine. Since the thickness of the vessel material depends directly on the diameter, vessels with large diameters are heavier and more expensive. Stainless steel cryogenic pressure vessels are expensive and need one inlet and outlet pipe. Two cryogenic pumps, expanders or turbines in two vessels need double piping efforts, and are more expensive then mounting two pumps, expanders or turbines in one vessel with larger length. This invention allows machine capacity to increase while keeping the vessel diameter the same by increasing the length of the vessel to house two machines. Lengthening a vessel requires relatively less material thickness and results in less weight, than increasing the diameter of a vessel, and is therefore much less expensive. Also, a longer two-machine vessel needs only one inlet and outlet pipe thereby reducing the amount of required piping, which is also a significant cost saving. Also, two vessels occupy double the ground space of longer two-machine vessel, which is also a significant cost saving. Also LNG vessels must be insulated against heat transfer from the environment to the LNG, and it is more effective and less expensive to insulate one longer vessel against two shorter ones.

While the present invention is described in the context of LNG, it is equally as applicable to other cold or cryogenic fuels or gases generally. This would be understood by a person skilled in the art. By way of example, the disclosed invention accommodates other hydrocarbons such as methane, ethane, propane and hydrocarbon derivatives. Further fuels and gases such as hydrogen, helium, nitrogen and oxygen all benefit as cryogens to the present invention.

The preferred embodiment of this invention has two separate machines mounted in a common cryogenic liquid pressure vessel. These machines can be configured to run in series, in parallel or individually. When installed in this configuration the higher powers demanded by present design conditions can easily be met with proven technology, and risks associated with larger electrical devices and rotordynamic concerns are eliminated. The machines do not have to be identical, they can in fact perform completely different functions as part of a complete system. For example, a liquid expander machine can be used for large scale expansion which feeds a smaller vaporizing expander, both in a common vessel. With regards to pumps, a primary machine can run at low speed to boost pressure to a larger secondary machine, which will improve overall NPSH (Net Positive Suction Head) performance.

Pumps, expanders and turbines are either with fixed rotational speed or with variable rotational speed, and their performance depends on their rotational speeds. One large machine has only one rotating shaft and can therefore only operate on one rotational speed. Two machines in a tandem configuration can have different speeds for two rotational shafts. Thus the operation of two machines is more flexible with two different speeds. For example, one machine at a vessel inlet can have a fixed rotational speed (e.g. 3000 rpm) and an upper machine, close to the outlet, can have a variable rotational speed (e.g. between 1000 to 4000 rpm), thus making the operational performance very flexible.

Other advantages and attributes of this invention will be readily discernable upon a reading of the text hereinafter.

### SUMMARY OF THE INVENTION

An aspect of this invention is to provide a compact configuration for cryogenic pumps and turbines.

A further aspect of this invention is to provide two separate cryogenic machines mounted in a common cryogenic pressure vessel and configured to operate in series, in parallel or individually.

These aspects, and others expressed or implied in this document, are found in a compact configuration for two cryogenic machines comprising a single cryogenic liquid vessel in which the two machines are disposed, supported and operable in tandem. In one embodiment the two cryogenic machines are operable in series or individually, and in another embodiment the two cryogenic machines are operable in parallel or individually. Preferably the machines are supported intermediately relative to the vessel, or at a top of the vessel. In various embodiments the machines are pumps or turbines or expanders.

### BRIEF DESCRIPTION OF THE DRAWINGS

FIG. 1 is a diagrammatical illustration of this invention in which two pumps are configured in parallel.

FIG. 2 is a diagrammatical illustration of this invention in which two pumps are configured in series.

FIG. 3 is a diagrammatical illustration of this invention in which two expanders are configured in series.

FIG. 4 is a diagrammatical illustration of this invention in which two expanders are configured in parallel.

FIGS. 5 and 6 are cross-sectional views with details of an intermediate support embodiment of this invention.

FIG. 7 is a cross-sectional view of a top support embodiment of this invention.

### DESCRIPTION OF THE PREFERRED EMBODIMENT

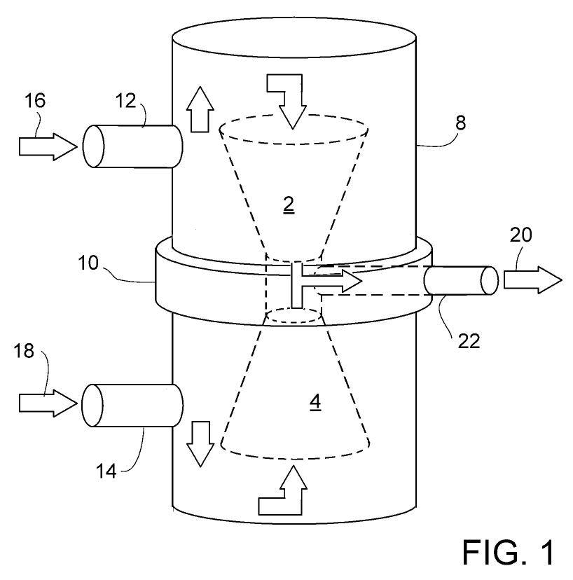

Referring to FIG. 1, two pumps, 2 and 4, are illustrated to be mounted in a common cryogenic vessel 8 by means of an intermediate support plate 10 and configured in parallel to create higher flow with less risk and lower cost than two pumps in separate vessels. The vessel 8 defines two cryogenic liquid inlets, 12 and 14, through which low pressure suction streams, 16 and 18, are drawn respectively into the pumps, 2 and 4. The outputs of the pumps are combined in a relatively high pressure discharge 20 via vessel outlet 22. The pumps can be run together or separately, but preferably operated at the same speed when in parallel operation. Significant advantages of this embodiment include partial capacity flexibility.

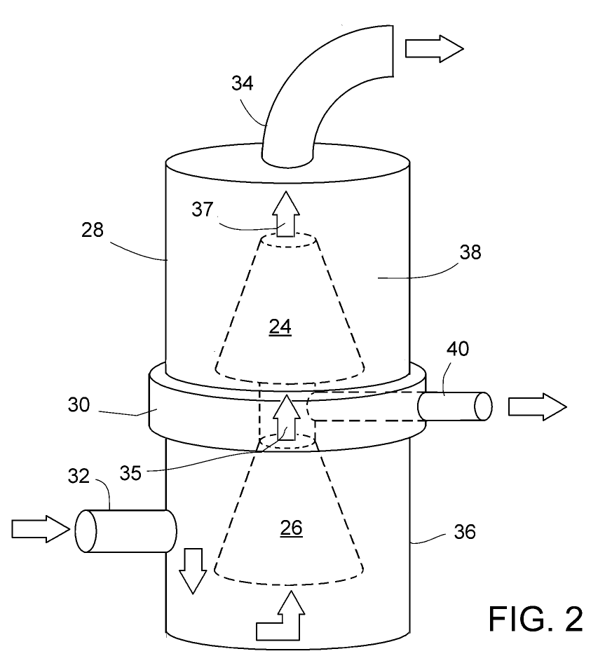

Referring to FIG. 2, two pumps, 24 and 26, are illustrated to be mounted in a common cryogenic vessel 28 by means of an intermediate support plate 30 and configured in series to create relatively higher pressure flow with less risk and lower cost than two pumps in separate vessels. The vessel 28 defines a primary suction inlet 32 and a high pressure discharge outlet 34. The lower pump 26 resides in a low pressure containment portion 36 of the vessel and the discharge 35 from the lower pump 26 is directed to the suction input of the upper pump 24 which resides in an intermediate pressure containment portion 38 of vessel 28. The discharge 37 from the upper pump exits the vessel via the vessel's outlet 34. Optionally there is an intermediate pressure discharge outlet 40 communicating with the discharge 35 of the lower pump. The pumps can be run together or separately, and can be operated at different speeds. This invention provides added capacity and flexibility.

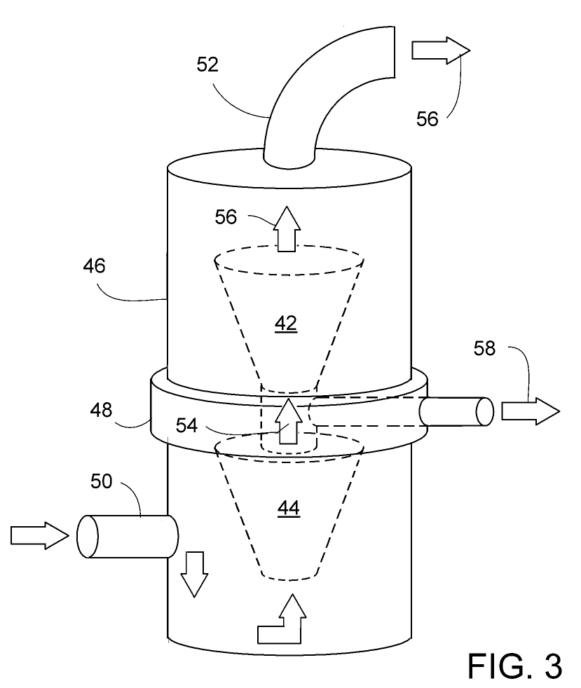

Referring to FIG. 3, two expanders, 42 and 44, are illustrated to be mounted in a common vessel 46 by means of an intermediate support plate 48 and are configured in series to create higher pressure with less risk and lower cost than two expanders in separate vessels. The vessel 46 defines a high pressure inlet 50 that communicates with a lower expander 44 and a low pressure discharge outlet 52. The output 54 of the lower expander 44 is directed to the input of an upper expander 42, and the output 56 of the upper expander communicates with the outlet 52. The low pressure discharge 56 can be single-phase or two-phase depending on how the expanders are operated. The expanders can be run together or separately. Speed and type can be independent. Optionally the vessel defines an intermediate pressure discharge 58 that is generally single-phase. Advantages of this embodiment include multi-phase capacity, reduced load capacity, independent maintenance, improved efficiency by virtue of greater flexibility.

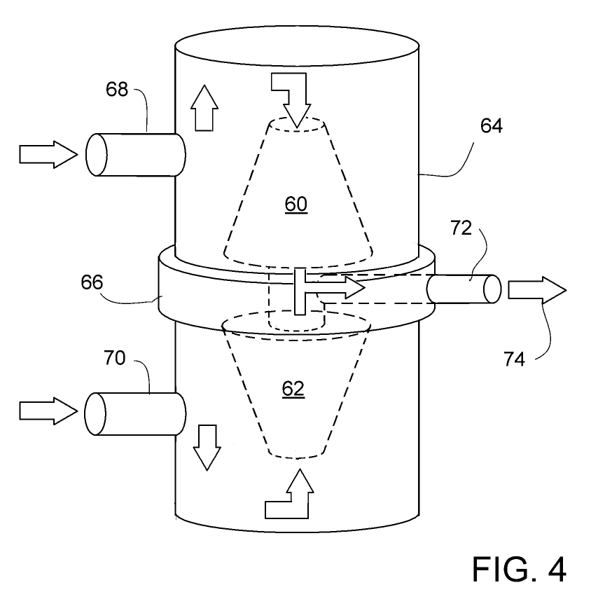

Referring to FIG. 4, two expanders, 60 and 62, are illustrated to be mounted in a common vessel 64 by means of an intermediate support plate 66 and configured in parallel to create higher flow with less risk and lower cost than two expanders in separate vessels. The vessel 64 defines two high pressure inlets, 68 and 70, communicating respectively with the inputs of the expanders, 60 and 62. The lower pressure discharges of the expanders are combined and directed to a low pressure discharge outlet 72. The low pressure discharge 74 can be single-phase or two-phase combined or individual streams. The expanders can be run together or separately at the same or different speeds. Advantages of this embodiment include greater flexibility for changes in flow conditions, use of separate types of expanders for single or two-phase flow, independent maintenance and greater efficiency.

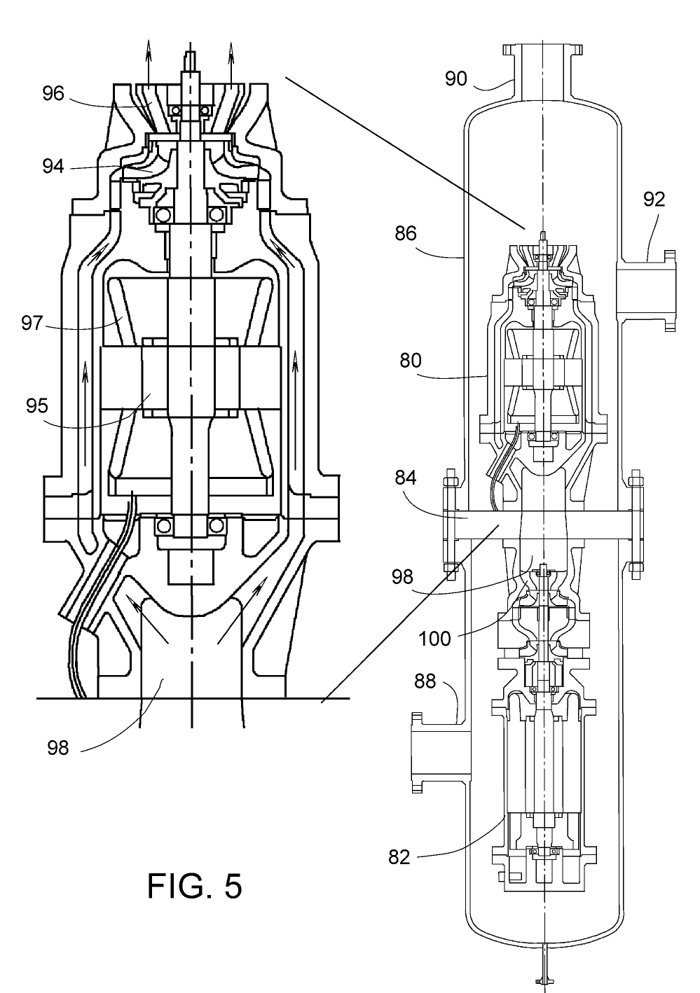

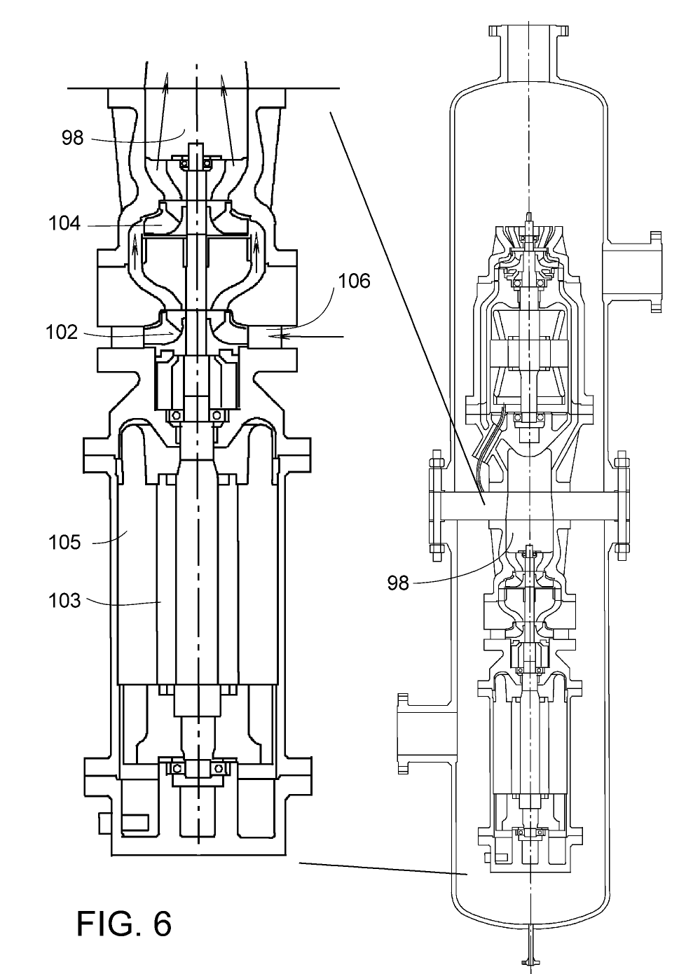

Referring to FIGS. 5-6, a combination of two separate expanders, 80 and 82, connected in line and fixed to an intermediate support plate 84 of a surrounding cryogenic pressure vessel 86 is illustrated. The vessel defines a high pressure liquid inlet 88, a two-phase discharge 90, and an optional liquid discharge 92. In these illustrations, the upper expander 80 is a two-phase variable speed expander, and the lower expander 82 is a constant speed liquid expander. The upper expander includes a two-phase runner 94, a two-phase exducer 96, a rotor 95 and a stator 97. The upper expander receives input via a channel 98 communicating with the discharge 100 of the lower expander. The lower expander includes a first stage liquid runner 102, a second stage liquid runner 104, a rotor 103, a stator 105, and a radial liquid inlet 106.

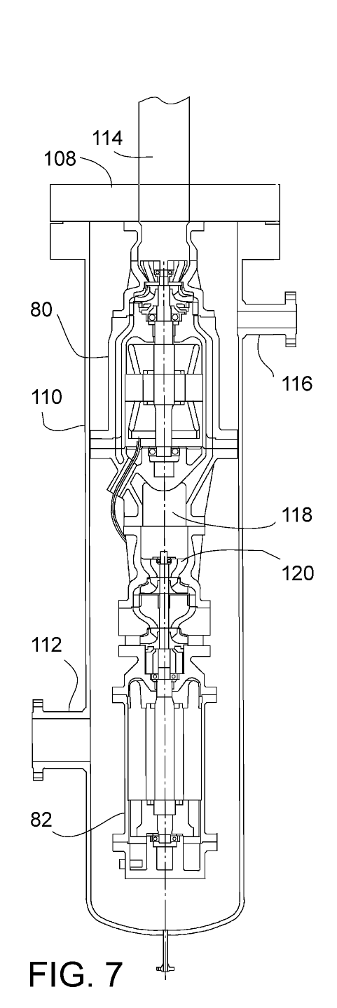

Referring to FIG. 7, a combination of two separate expanders, 80 and 82, connected in line and fixed to a top support plate 108 of a surrounding cryogenic pressure vessel 110 is illustrated. The vessel defines a high pressure liquid inlet 112, a two-phase discharge 114, and an optional liquid discharge 116. The upper expander receives input via a channel 118 communicating with the discharge 120 of the lower expander. In these illustrations, the upper and lower expanders are identical to those in FIGS. 5 and 6. The main difference is how the expanders are supported.

It should be understood that the embodiments illustrated in FIGS. 5-7 are only detailed examples of how this invention can be applied to achieve the aforesaid advantages. Further embodiments can be any two-machine combination of pumps, turbines and expanders.

As can be seen, the basic configuration illustrated in FIGS. 5-7 is of one machine in a pressure vessel disposed at a vessel inlet and having a fixed rotational speed (e.g. 3000 rpm), and a second machine disposed above the first in the vessel close to an outlet, the second machine having a variable rotational speed (e.g. between 1000 to 4000 rpm). This configuration of two machines in tandem in one vessel and their respective rotational characteristics makes the overall operational performance very flexible.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims.

I claim:

1. A compact configuration for two cryogenic machines comprising a single cryogenic liquid vessel in which the machines are disposed, supported and operable in tandem.

2. The compact configuration according to claim 1 wherein the two cryogenic machines are operable in series or individually.

3. The compact configuration according to claim 1 wherein the two cryogenic machines are supported intermediately relative to the vessel.

4. The compact configuration according to claim 1 wherein the two cryogenic machines are supported from a top of the vessel.

5. The compact configuration according to claim 1 wherein the two cryogenic machines are operable in parallel or individually.

6. The compact configuration according to claim 5 wherein the two cryogenic machines are supported intermediately relative to the vessel.

7. The compact configuration according to claim 5 wherein the two cryogenic machines are supported from a top of the vessel.

8. A compact configuration for two cryogenic pumps comprising a single cryogenic liquid vessel in which the pumps are disposed, supported and operable in tandem, the pumps being operable in parallel or individually.

9. The compact configuration according to claim 8 wherein the two cryogenic pumps are supported intermediately relative to the vessel.

10. The compact configuration according to claim 8 wherein the two cryogenic pumps are supported from a top of the vessel.

11. A compact configuration for two cryogenic pumps comprising a single cryogenic liquid vessel in which the pumps are disposed, supported and operable in tandem, the pumps being operable in series or individually.

12. The compact configuration according to claim 11 wherein the two cryogenic pumps are supported intermediately relative to the vessel.

13. The compact configuration according to claim 11 wherein the two cryogenic pumps are supported from a top of the vessel.

14. A compact configuration for two cryogenic expanders comprising a single cryogenic liquid vessel in which the expanders are disposed, supported and operable in tandem, the expanders being operable in parallel or individually.

15. The compact configuration according to claim 14 wherein the two cryogenic expanders are supported intermediately relative to the vessel.

16. The compact configuration according to claim 14 wherein the two cryogenic expanders are supported from a top of the vessel.

17. A compact configuration for two cryogenic expanders comprising a single cryogenic liquid vessel in which the expanders are disposed, supported and operable in tandem, the expanders being operable in series or individually.

18. The compact configuration according to claim 17 wherein the two cryogenic expanders are supported intermediately relative to the vessel.

19. The compact configuration according to claim 17 wherein the two cryogenic expanders are supported from a top of the vessel.
